(19) United States
(12) Patent Application Publication
(10) Pub. No.: US 2026/0056364 A1
(43) Pub. Date: Feb. 26, 2026

(54) OPTICAL FIBRE CONNECTOR

(71) Applicant: OXFORD FIBER LIMITED, Warwickshire (GB)

(72) Inventors: Ian MURGATROYD, Warwickshire (GB); Kazimierz WOJEWODA, Warwickshire (GB)

(73) Assignee: OXFORD FIBER LIMITED, Warwickshire (GB)

(21) Appl. No.: 19/105,581

(22) PCT Filed: Oct. 12, 2022
(86) PCT No.: PCT/GB2022/052579

§ 371 Date: Feb. 21, 2025

(30) Foreign Application Priority Data
Oct. 15, 2021 (GB) 2114790.5

(51) Int. Cl. G02B 6/25; G02B 6/38; G02B 6/40

(52) U.S. Cl. CPC G02B 6/25; G02B 6/3822; G02B 6/3838; G02B 6/3846; G02B 6/3847; G02B 6/3861; G02B 6/387; G02B 6/403

(57) ABSTRACT

An optical fibre connector for connecting to a complementary optical fibre connector is provided. The optical fibre connector comprises a ferrule comprising a coupling face for coupling with a complementary coupling face of said complementary optical fibre connector; and an optical fibre for optically mating with a complementary optical fibre of the complementary optical fibre connector, the optical fibre extending through the ferrule along a fibre axis and having a mating endface being exposed at the coupling face of the ferrule. A profile of the mating endface is formed and finished by cleaving.

### TECHNICAL FIELD

The present invention relates to the field of connectors for optical fibres and the connectorisation of optical fibres.

### BACKGROUND

There are a range of known techniques for joining together optical fibres. A first option is to perform a fusion splice i.e. directly melting and fusing two fibres together to form a continuous join between the two fibres. Although high quality fusion splices can be performed, the process is laborious, slow, and requires expensive specialised equipment. A second option is to fit interlocking connectors to the ends of the two fibres—i.e. connectorisation of the fibres. The connectors plug together and ensure that the fibres are held in alignment, thereby providing a good quality connection with minimal signal loss.

Many installations require the use of multi-fibre cables to handle the high volumes of data being transmitted. Multi-fibre cables include multiple individual optical fibres and can be arranged as a bundle or rope, or as a ribbon with the fibres aligned in a plane. Connectorising a multi-fibre cable is more difficult than a single fibre-due to the number of fibres which each need to be connected there are many more potential points of failure.

Fitting connectors requires stripping off the protective coating from the end of an optical fibre before inserting the fibre into a connector. The exposed end of the fibre and connector are normally polished to remove any defects and ensure a clean connection can be obtained with the next fibre in a complementary connector, thus minimising signal losses. However, polishing an optical fibre is a skilled and laborious process.

### SUMMARY OF INVENTION

According to a first aspect of the invention there is provided an optical fibre connector for connecting to a complementary optical fibre connector. The optical fibre connector comprises a ferrule comprising a coupling face for coupling with a complementary coupling face of said complementary optical fibre connector; and an optical fibre for optically mating with a complementary optical fibre of the complementary optical fibre connector, the optical fibre extending through the ferrule along a fibre axis and having a mating endface being exposed at the coupling face of the ferrule. A profile of the mating fibre endface is formed and finished by cleaving.

Forming the mating endface by cleaving provides a mating endface that is optical and sufficiently smooth to allow the passage of light across the endface from the optical fibre to the complementary optical fibre. Cleaving an optical fibre provides an improved endface in comparison to polished endfaces which often suffer from misting and scratches. Cleaved surfaces are normally relatively “mirror” smooth and have a low likelihood of comprising a rough surface and/or scratches. Cleaving is also a relatively quick procedure. For example, it may take around 5 seconds to cleave an optical fibre (or an optical fibre ribbon), and therefore cleaving 12 fibres can be undertaken within 5 minutes, in comparison to 30 minutes or more taken for polishing a batch of 12 optical fibres. Cleaving provides a consistent and more reliable mating endface profile. These advantages are particularly beneficial when optical fibres must be connectorised on-site. Furthermore, optical fibre connectors can be manufactured more cheaply and are more customisable, for example, by varying the type/configuration of cleaving in order to provide different types of mating fibre endface profiles. As used herein, a profile of the mating fibre endface is formed and finished by cleaving if it does not subsequently undergo a polishing step after being cleaved.

The profile of the mating endface may be formed by mechanical cleaving or laser cleaving.

Optionally, the mating endface is at an acute angle with respect to the fibre axis.

Optionally, the acute angle is from 70 to 85 degrees and preferably 81 to 84 degrees.

The acute angle may be 82 degrees. The acute angle may alternatively be defined as an angle of the mating endface with respect to a plane that is perpendicular to the fibre axis, in which case the angle may be in the region of 5 to 20 degrees, 6 to 9 degrees, or, 8 degrees. When the mating endface is at the acute angle, optical back-reflections are reduced or removed. Furthermore, reduction of optical back-reflections reduces or even avoids damage to the optical system which may occur in the presence of reflections. The angle can be controlled via the direction of cleaving of the mating endface. It is advantageous to provide an angled mating endface via cleaving rather than via the use of polishing for the reasons discussed above.

Optionally, the mating endface is perpendicular to the fibre axis.

A mating endface that is perpendicular to the fibre axis (also known as a “square cleave”) provides for a particularly cheap and easy-to-manufacture connector.

Optionally, the mating endface is coated in an anti-reflection coating.

The anti-reflection coating reduces back-reflections and optical losses at the mating endface. Furthermore, where there is an air-gap beyond the mating end-face (as will be discussed below), the insertion loss is more stable since optical standing waves are not set up in the air gap.

Optionally, the ferrule coupling face is parallel to the mating endface.

Optionally, the ferrule coupling face is perpendicular to the fibre axis.

Optionally, the mating endface has been tension cleaved.

Cleaving requires that stresses in the fibre propagate a crack across a fibre to form a cleave; the starter crack may arise from a scratch, in the case of a mechanical cleave, or from damage induced by a laser beam or similar. Angled cleaving arising from lateral deflection of a fibre clamped at two points and scratched therebetween will give a more rounded, angled end face. A flatter, yet still angled, end face can be achieved by tensioning as well as deflecting the clamped and scratched fibre. In this way, tension cleaving the mating endface provides for a more flat, yet angled, endface, thereby reducing the insertion loss.

Optionally, the optical fibre is glued into the ferrule.

The fibres may be glued into the ferrule using an epoxy material.

Optionally, the fibre endface is recessed from the ferrule coupling face.

Optionally, the fibre endface is recessed at a recess distance from the ferrule coupling face, the recess distance being from 0 micrometres or 2 micrometres, to 25 micrometres, or from 3 micrometres to 15 micrometres, or 6 micrometres. The recess distance may be from 0 micrometres to 3 micrometres. Any range herein referencing “from 0” micrometres, may refer to “more than 0”, or, “from 0.01 micrometres”.

Recessing the fibre within the ferrule coupling face provides for there to be an air gap between mating endfaces of the optical fibre and complementary optical fibre when the connector is in-use. The presence of the air gap advantageously prevents physical grinding from occurring between the ends of optical fibres, particularly when a connection is made or unmade multiple times. Furthermore, the effect of dust on the quality of the optical connection is reduced. Dust may prevent close contact between the mating endfaces of the optical fibres and for conventional physical contact connectors, the endfaces are no longer in contact and the optical transmission characteristics will change dramatically. In particular, the insertion loss will become highly unstable. In contrast, for an air-gap connector, dust will merely slightly increase the separation of the endfaces and this will only marginally change the optical transmission. In addition, a connection made with air gap connectors can be sprung together by any springs in the connector housings with a very much reduced force compared to a conventional, physical contact connector because there is no requirement to maintain physical contact.

When the mating endfaces are optionally coated with an anti-reflection coating as discussed above, then back-reflection and optical loss within the air gap is minimised, due to the reduction or even elimination of optical standing waves, thereby improving the stability of the insertion loss across the connection.

Optionally, a tip of the fibre mating endface is coincident with the ferrule coupling face. It would be understood that in embodiments wherein the optical fibre has been cleaved at an angle, the tip of the fibre mating endface may be coincident with the ferrule coupling face while the remainder of the fibre mating endface (including the core of the optical fibre) is recessed from the ferrule coupling face.

Optionally, the fibre endface protrudes from the ferrule coupling face by a protruding distance being from 0.01 micrometre to 9 micrometres, or, 1 micrometre to 6 micrometres, or, 1 micrometre to 3.5 micrometres.

Use of a protruding endface may improve compatibility with existing connectors.

Optionally, the optical fibre connector may comprise a plurality of optical fibres. E.g. the optical fibre connector may be configured for use with a multi-fibre cable or ribbon fibre comprising a plurality of optical fibres. A ribbon-fibre cable is a multi-fibre cable in which the optical fibres are aligned in a single plane. Each of the plurality of optical fibres may have a corresponding cleaved mating endface exposed at the coupling face of the ferrule, and wherein each of the mating endfaces are substantially parallel to one another.

Optionally, the plurality of optical fibres comprises 2, 4, 6, 8, 12, 16 or more optical fibres, which may be in accordance with normal industry practice. The use of cleaving for forming the mating endface for multi-fibre or ribbon fibre connectors is advantageous, since obtaining an optical endface surface by polishing such connectors is particularly time-consuming. Furthermore, the optical fibre may be a single or multi-mode fibre. In one series of embodiments, the optical fibre connector may comprise multiple rows of optical fibres. For example, the optical fibre connector may be configured for use with multiple ribbon fibres and/or multiple layers of optical fibres aligned in a plane. There may be 2, 4, 6, 8, 12, 16 or greater optical fibres per row. There may be 2, 3, 4, 5, 6 or greater rows of fibres. Each row of fibres would be separately cleaved and secured within the connector as described herein. The optical fibres in each row may be aligned or they may be laterally offset between rows for denser packing within the connector.

Optionally, the optical fibre is an optical fibre stub, wherein one end of the optical fibre stub comprises the mating endface, and the other end of the optical fibre stub is connectable to an optical fibre cable.

Optionally, the optical fibre stub comprises a tail endface at an end which is opposite to the mating endface, the tail endface having been cleaved and comprising a surface that is perpendicular to the fibre axis.

The optical fibre stub may be a portion of optical fibre, stripped of any outer jacket and cladding, which is of a length suitable for incorporating into an optical fibre connector, where one end of the stub is the mating endface, and the other end is the tail endface, wherein the tail endface is suitable for splicing with an optical fibre cable in order to “connectorise” the optical fibre cable. The tail endface may be configured to be mechanically spliced or fusion spliced with the optical fibre cable. In this manner, it is possible to provide a pre-built optical fibre connector including the fibre stub. A user wishing to connectorise the optical fibre cable merely needs to splice an end of the optical fibre cable with the tail endface, thereby reducing the workload on the user.

According to a further aspect of the invention there is provided an optical fibre cable comprising: at least one optical fibre and at least one optical fibre connector as discussed above at an end thereof, wherein the optical fibre is spliced with the tail endface of the optical fibre stub. In some embodiments, the optical fibre cable may comprise at least one optical fibre connector as discussed herein on each end thereof.

According to a further aspect of the invention there is provided a connector system comprising a pair of optical fibre connectors according to any preceding claim, wherein the coupling face of the ferrule of one of the pair of optical fibre connectors is contactable with the coupling face of the ferrule of the other of the pair of optical fibre connectors.

Optionally, at least one of the optical fibre connectors comprises a fibre mating endface being recessed from the ferrule coupling face such that an air gap is provided between the fibre mating endfaces of each of the pair of optical fibre connectors when the coupling faces of the ferrules of the pair of optical fibre connectors are in contact with one another.

Optionally, the air gap is from 0 to 25 micrometres.

The air gap may be 1 to 25 micrometres, 2 to 8, 3 to 7, 4 to 6, or substantially 5 micrometres.

Optionally, the connector system further comprises index matching material adjacent one or both of the fibre mating endfaces of each of the pair of optical fibre connectors, thereby filling the air gap when the coupling faces of the ferrules of the pair of optical fibre connectors are in contact with one another.

According to a further aspect of the invention there is provided a method of manufacturing an optical fibre connector, the method comprising: providing an optical fibre extending along a fibre axis; cleaving the optical fibre to provide a mating endface at one end of the optical fibre, thereby finishing forming the optical fibre; providing a ferrule comprising a coupling face and a recessed channel having an opening at the mating face; locating the optical fibre within the recessed channel such that the mating endface is exposed at the mating face of the ferrule; and securing the optical fibre in position.

Optionally, the mating endface is cleaved at an acute angle with respect to the fibre axis.

Optionally, the acute angle is from 70 to 85 degrees, and preferably 81 to 84 degrees. The acute angle may be 82 degrees.

Optionally, the method further comprises the step of applying an anti-reflection coating to the mating endface of the fibre stub.

Optionally, the anti-reflection coating is applied in a vacuum chamber.

Optionally, the cleaving comprises tension cleaving.

Optionally, the step of securing the optical fibre in position comprises gluing the optical fibre to the ferrule.

Optionally, the optical fibre is a multi-fibre cable or ribbon fibre comprising a plurality of optical fibres, wherein the step of cleaving comprises cleaving the multi-ribbon fibre cable or ribbon fibre.

The optical fibres may be optical fibre stubs having a tail endface at the end opposite to the mating endface. The method may comprise splicing the tail endface to an optical fibre cable. The splicing may be mechanical or fusion splicing.

Optionally, the method further comprises, before the step of locating the optical fibre: providing a temporary stop (or spacer) across the opening at the mating face, or, within the recessed channel, and wherein the step of pushing comprises pushing the optical fibre into the recessed channel towards the opening at the mating face from within the recessed channel until the mating endface of the optical fibre abuts with the temporary stop; gluing the fibre stub to the ferrule; and removing the temporary stop.

Optionally, the method further comprises locating, and fixing into position, the cleaved optical fibre substantially flush with the end of the ferrule. A spacer layer is placed on or adhered to the end of the ferrule such that the ferrule mates with a corresponding ferrule, with the formation of an air gap between the two mating fibre ends. The spacer thickness is preferentially in the range of 1 to 15 micrometres, an intermediate value or preferentially 5 to 15 microns thick. The cleaved fibre end may be angled cleaved and the cleaved end may be anti-reflection coated.

### BRIEF DESCRIPTION OF DRAWINGS

FIG. 1 shows a schematic diagram of an optical fibre connector according to this disclosure.

FIGS. 2a-2c show alternative configurations of a fibre end-face and ferrule coupling face of two connectors according to this disclosure when mated together.

FIGS. 3a and 3b show a perspective and cross-sectional side diagrammatic views of an optical fibre connector according to this disclosure in attachment with a complementary optical fibre connector.

FIG. 4 shows a close-up cross-sectional side diagrammatic view of an interface between two optical fibre connectors according to FIGS. 3a and 3b.

FIGS. 5a and 5b are plots showing test results comparing the insertion loss performance of fibre optic connectors according to this disclosure with that of alternative, physical contact fibre optic connectors.

FIGS. 6a and 6b are plots showing test results comparing the return loss performance of fibre optic connectors according to this disclosure with that of alternative fibre optic connectors.

FIG. 7 shows a process flow diagram of a method according to this disclosure.

### DETAILED DESCRIPTION

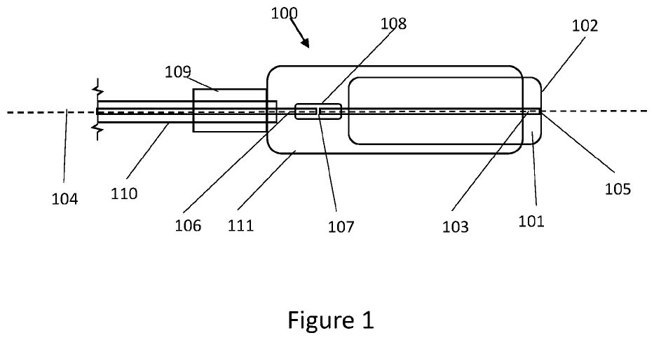

With reference to FIG. 1, an optical fibre connector 100 comprises a ferrule 101. The ferrule comprises a coupling face 102 for coupling with a complementary optical fibre of a complementary optical fibre connector (not shown). An optical fibre 103 extends through the ferrule and along a fibre axis 104. The optical fibre 103 comprises a mating endface 105 exposed at the coupling face 102 of the ferrule 101. A profile of the mating endface 105 is formed and finished by cleaving.

It is important for the mating endface 105 to have good optical properties in order that light can traverse across the mating endface 105 to a complementary mating endface (not shown) with a low insertion loss. Forming the mating endface 105 by cleaving provides for a smooth surface that provides such properties, and avoids any requirement to polish the endface 105, which is time-consuming. Cleaving the mating endface 105 further enables easy and consistent customisation of the mating endface, for example, enabling easy control of an angle of the mating endface 105 with respect to the fibre axis 104. The method of cleaving of the mating endface 105 may comprise mechanical cleaving and/or laser cleaving. These principles also apply to an optical fibre connector where the optical fibre is a multi-fibre ribbon or ribbon fibre, wherein multiple optical fibres—e.g. 2, 4, 6, 8, 12, 16 or more fibres, are placed adjacent to one another. In this case, the mating endfaces of all of the multiple optical fibres in a ribbon fibre are created at the same time, by cleaving the multi-fibre ribbon.

The mating endface 105 may be formed by cleaving using a fibre cleaving machine such as the Oxford Fiber® Ox-SAC-08, Ox-SAP-08 machines, or where the optical fibre is a multi-fibre ribbon, the Oxford Fiber® Ox-RAC-08 machine.

Preferably, the optical fibre 105 is glued into the ferrule 101, e.g. by using an epoxy material.

With continued reference to FIG. 1, the optical fibre 103 may be regarded as an optical fibre stub. The optical fibre stub may be spliced (or configured to be spliced) to an external fibre 106 at a splice location 107, which may be protected by a splice protector 108. Alternatively (not shown), the optical fibre 103 may be integral with an external fibre. A strain relief boot 109 may be placed between an external cable 110 carrying the external fibre 106, and a housing 111 of the connector 100, thereby protecting the housing 111 and cable 110 from wear.

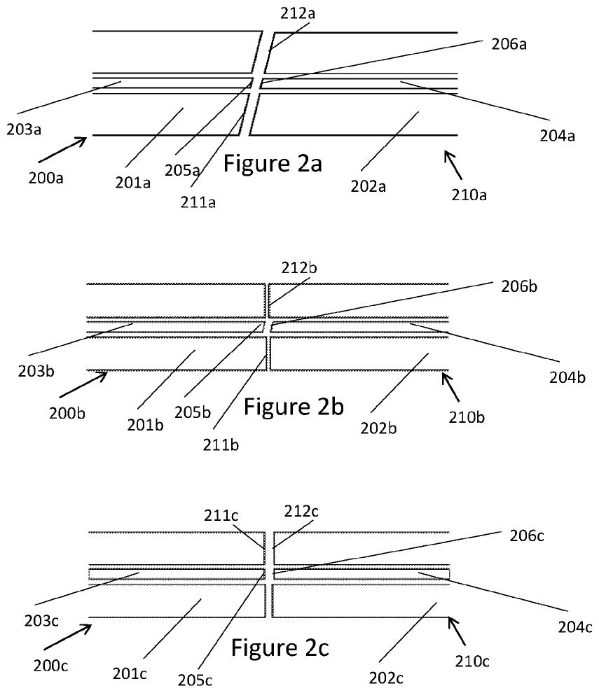

With reference to FIGS. 2a-2c there are shown alternative configurations of a joined pair of optical fibre connectors 200a-c, 210a-c. Each optical fibre connector comprises a ferrule 201a-c, 202a-c. Each ferrule 201a-c, 202a-c comprises a ferrule coupling end 211a-c, 212a-c. Within each optical fibre connector 200a-c, 210a-c there is an optical fibre 203a-c, 204a-c, each optical fibre comprising an end-face 205a-c, 206a-c.

FIG. 2a shows optical fibres 203a, 204a, with mating endfaces 205a, 206a having an angled cleave. Typically, the mating endfaces are cleaved an angle of 8 degrees with respect to a plane perpendicular to a centroid axis of the optical fibre 203a, 204a. Mating end faces with angles in the range of 4 to 15 degrees are also envisaged. The ferrule coupling ends 211a, 212a can be moulded or polished to be angled to the same extent as the mating endfaces 205a, 206a. An advantage of the configuration of FIG. 2a is improved compatibility with industry standard angled ferrules.

FIG. 2b shows optical fibres 203b, 204b, with mating endfaces 205b, 206b having an angled cleave. The ferrule coupling end 211b, 212b is perpendicular to a centroid axis of the fibres 203b, 204b—i.e. square ended. Advantageously, the configuration of FIG. 2 is low-cost and does not require polishing of the ferrule coupling ends 211b, 212b. The optical performance of the configuration of FIG. 2b is similar to that of the configuration of FIG. 2a. The use of the angled cleaved fibre endfaces 205b, 206b significantly reduces back-reflection.

FIG. 2c shows optical fibres 203c, 204c, with mating endfaces 205c, 206c having cleave that is perpendicular to a centroid axis of the fibres 203c, 203b—i.e. a square cleave. The ferrule coupling ends 211c, 212c are square ended. This configuration is particularly cheap and easy to construct.

The optical fibres 203a-c, 204a-c may be single mode or multi-mode.

The mating endfaces of the optical fibres, e.g. as per FIGS. 2a-2c, may protrude or be recessed within the corresponding ferrule. With particular reference to FIG. 2b, the mating endfaces may sit such that a tip of the fibre 203b, 204b, is in contact with a plane that is parallel to the corresponding ferrule coupling face 211b, 212b. Where the mating endfaces 205b, 206b are angled, and, the ferrule coupling faces 211b, 212b are square as shown in FIG. 2b, there may be an air-gap in-between the cores of the optical fibres comprising the mating endfaces 205b, 206b.

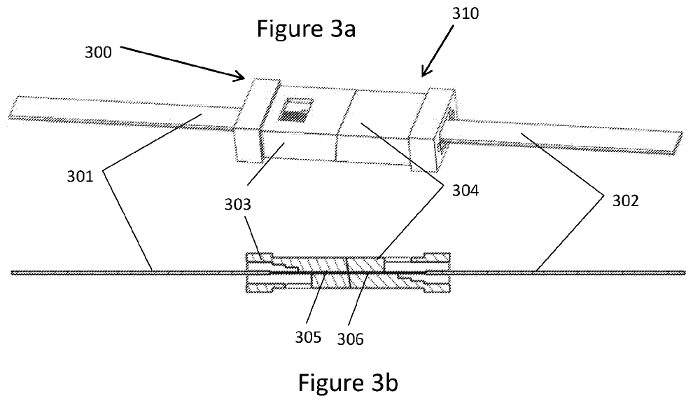

With reference to FIGS. 3a and 3b, there is shown an optical fibre connector 300 connected to a complementary optical fibre connector 310, both fibre connectors being utilised to join two multi-fibre ribbon cables 301, 302 together. The optical fibre connectors may be within a housing (not shown). Each optical fibre connector 300, 310 comprises a ferrule 303, 304. An optical fibre 305, 306 corresponding to each of the ribbon cables 301, 302 is located within each corresponding ferrule 303, 304.

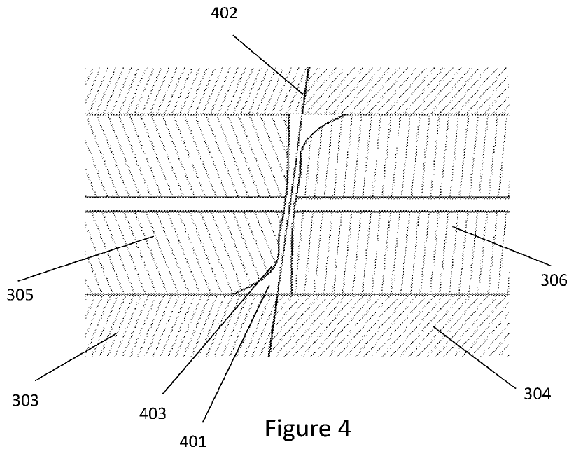

FIG. 4 shows a close-up of the interface between the optical fibres 305, 306 of FIGS. 3a and 3b. An air gap 401 is located between the optical fibres 305, 306, which are not in contact with each other. An interface 402 between the ferrules 303, 304 is optionally angled with respect to the direction of the fibre, due to the adjoining ends of the ferrules 303, 304 being angled.

In the example of FIGS. 3a, 3b, and 4, the optical fibres 305, 306 are one fibre of multi-fibre ribbons, and the optical fibre connector 300 is utilised to connectorise and join a multi-fibre ribbon, e.g. containing 12 fibres. However, the same principles may be applied to a single optical fibre. For ease of discussion, the optical fibre 305 is hereinafter discussed as a single fibre. The end of the ferrule 303 (adjoining interface 402) may be angled in order to reduce optical back reflections. The optical fibre 305 has a mating endface 403 that has been cleaved, preferably at an angle, in order to obtain a smooth finish thereby enabling light transmission with a low insertion loss. The angle may be 8 degrees with respect to a plane perpendicular to the axis of the optical fibre to reduce transmission of optical reflections back down the fibre. The cleaving may be undertaken by laser cleaving or mechanical cleaving. Preferably the entire multi-fibre ribbon has been stripped of all coating/cladding before being cleaved. The cleaving may be undertaken mechanically by the Oxford Fiber® Ox-RAC-08 cleaving machine. Preferably, a tensioning angled ribbon cleaver is utilised to undertake the cleaving in order to provide flat yet angled cleaved end face and satisfactory cleaved surface. It has been found that utilising tension cleaving provides an endface which reduces the insertion loss at the endface by 0.1-0.2 dB in comparison to when an angled end face is achieved by lateral deflection of a clamped and scratched fibre for which the angled end face is more curved. The stripped and cleaved multi-fibre ribbon is located into the ferrule 303 and glued into place. It is not necessary to polish the mating endface 403, since the smoothness obtained from the cleaving procedure is sufficient to enable the satisfactory transmission of light. The optical fibres may be coated with an anti-reflection coating comprising alternate layers of high and low refractive index, for instance zirconia and silica. This coating prevents formation of unwanted optical standing waves in the connector and reduces insertion loss which would otherwise be present due to reflections from the cleaved end faces.

In order for the air gap 401 to exist, the optical fibre 305 must be recessed within the ferrule 303. The optical fibre 305 may be recessed within the ferrule 303 in the region of 3.5 to 25 microns, or, in the range of 3 to 10 micrometres, or, by 6 micrometres. The recess distance may be in relation to the core of the fibre and the coupling face of the ferrule. It has been found that recessing an optical fibre by up to 10 micrometres leads to a minimal excess insertion loss of 0.1 dB caused directly by the recessing. Incorporation of the air gap 401 has several advantages. There is no physical grinding between the mating endface 403 of the optical fibre 305, and the corresponding endface of the complementary fibre 306, which results in increased durability of the connectors. Furthermore, the effect of any dust present is mitigated since any particles of dust will only marginally increase the distance of the recess. For comparison, in conventional connectors which ensure that the endfaces of the optical fibres are pressed together in physical contact, any dust particles between the endfaces could cause an unexpected breakage in physical contact leading to unexpected light reflections and unstable insertion loss. The use of an air gap ferrule reduces the force with which mating connectors need to be pushed together. For example, a typical optical fibre connector requires the optical fibres to be pushed together with a force of around 10N, typically provided by a spring. The present invention, however, has a pushing force less than 5N, which reduces the wear on the fibres and does not suffer from unacceptable transmission losses. A further advantage is found in optical fibre connectors which comprise multiple rows of optical fibres. For a 48 fibre connector, a typical connector would be arranged in 4 rows of 12 fibres, with each row requiring a contact force of around 10N. Thus the connector requires over 40N of spring force in total to ensure that all pairs of optical fibres are in contact. This makes the connector very unreliable. In contrast, an equivalent optical fibre connector according to the present invention would require less than 20N of spring force to contact the 4 rows of optical fibres, which improves reliability and minimises transmission losses.

Where the mating endface 403 of the optical fibre is angled, a preferred range is 4-20 degrees and preferably 6-9 degrees with respect to a plane that is perpendicular to an axis extending along the core of the fibre 305. This angle provides for optical reflections not to be transmitted back down the fibre, without causing undue loss in transmission to the complementary fibre 306. It has been found that the range of angles of 6-9 degrees with respect to a plane that is perpendicular to the optical axis of the fibre is effective in suppressing back-reflections.

It has also been found that an air gap 401 caused by a recess distance of 3-10 micrometres, i.e. the distance between the end of the cores of the fibres and the plane parallel to the end of the ferrule, provides reduced optical reflection without any significant impact on insertion loss of the optical transmission. The recess distance can be considered to be the distance between the ends of the cores of the fibres and the plane parallel to the end of the ferrule 303.

An air gap of less than 3 microns is also envisaged, in which the fibres are recessed by zero to 3 microns from the plane parallel to the end of the ferrule 303. Angle cleaved fibres with these smaller air gaps are effective in eliminating back-reflections and minimising optical loss between two mating connectors. However, there is a danger of physical contact between the cleaved angled fibre ends and fibres which may protrude by up to 3.5 micrometres from the polished end of a conventional physical contact connector, in which case the cleaved fibre ends and the polished fibre ends may rub together causing damage.

The optical fibre 305 may be non-recessed within the ferrule 303, and instead may have a mating endface 403 that is coincident with the coupling surface of the ferrule (corresponding to interface 402 in FIG. 4). To produce this construction, a cleaved fibre 305 is pushed into the ferrule 303 towards the coupling surface of the ferrule 303 where the cleaved fibre 305 is to be exposed (corresponding to surface 102 in FIG. 1). The coupling surface is blocked off by a stop (not shown) in the form of a flat plate which is pressed against the surface of the ferrule and therefore the fibre 305 is pushed until it abuts against the stop plate. The fibre 305 is subsequently glued in place, before the stop plate is removed. It is also understood that fibres which are initially positioned to be flush with the end face of the ferrule using this method, after gluing, may change their positions slightly, due to shrinkage effects of the glue. Consequently, after gluing, the end of the fibres may be slightly recessed from the end of the ferrule, generating an air gap in the subsequent connector. Alternatively, the optical fibres may protrude slightly.

In order to produce a connector having a recessed fibre 305, a similar constructional method as described in the previous paragraph is utilised. However, the stop is achieved by using a stop ferrule which contains protruding fibres. The stop ferrule and the connector's ferrule are aligned using alignment pins and so the fibre protruding from the stop ferrule enter the interior of the ferrule 303. The fibre 305 is pushed until it abuts against the protruding fibre of the stop ferrule. The location of the fibre 305 within the ferrule 303, i.e. the amount of recessing, is controlled by the length of the abutted protruding fibres of the stop ferrule. For example, if the stop ferrule has a fibre protruding by 6 micrometres, then the fibre 305 will be recessed by 6 micrometres within the ferrule 303, provided the stop ferrule and connector ferrule 303 are pushed flush with each other. Where the fibre 305 is a multi-fibre ribbon, the stop ferrule may comprise multiple corresponding protruding fibres for abutting with each fibre of the multi-fibre ribbon. A stop ferrule with fibres protruding by the desired amount may be prepared by polishing. Advantageously, where multiple fibres of a ribbon fibre are pushed against the stop ferrule, or against the flat plate described previously, any fibres of slightly incorrectly longer length, that may arise due to an inaccuracy during the cleaving process, are slightly buckled, thus being equalised in length with the remaining fibres in the ribbon.

Alternatively, or in addition to using fixed stops as described above, the cleaved optical fibre ends may be positioned by measuring and then setting their recess or protrusion with respect to the end face of the ferrule and subsequently glued into position. In order to measure, adjust, and glue the fibres in the ferrule, the cleaved fibres may be inserted into the ferrule and mounted in an interferometer (e.g. a “Daisi” interferometer as produced by Data-Pixel of Lyon, France). White light interference fringes are generated and hence the relative recess or protrusion of each fibre in the ribbon with respect to the ferrule end face can be measured. Equalising the recess or protrusion of each fibre in the ribbon can be achieved by rotating the plane of the ribbon with respect to the ferrule. The average recess or protrusion can be adjusted by sliding the fibre ribbon in to or out of the ferrule. The fibres may then be glued into the ferrule. Suitable glues include cyano-acrylate, epoxy, UV-cured epoxy and heat-set UV-cured epoxy. The final recess distance or protrusion distance of the fibres with respect to the ferrule end face may then be measured. This contactless positioning of the fibre ends has the advantage that the fibres are not damaged or dirtied by contact with a physical stop.

An anti-reflective coating may be applied to the fibre endface 403. The anti-reflective coating may comprise alternate layers of zirconia and silica. The anti-reflective coating may be applied before or after the fibre 305 is located, and possibly glued in place, in the ferrule 303. The anti-reflective coating may be applied whether or not the fibre 305 is recessed within the ferrule 303. Where the fibre 305 is recessed within the ferrule 303, the anti-reflective coating reduces back reflection and optical losses at the resulting air gap 401. Furthermore, optical standing-waves within the air gap are prevented thereby providing a stable insertion loss at the air gap 401. It has been found that for lightwaves having wavelengths in the range of 1250 to 1650 nm, the anti-reflective coating can reduce the amount of back reflectance by more than 90%.

As per the discussions above, this disclosure provides an optical fibre connector, optionally with a recessed (or non-recessed) mating endface of the optical fibre within a ferrule, with excellent optical transmission properties, without requiring the use of polishing. Furthermore, a precise location of the mating endface 403 of an optical fibre in relation to a ferrule coupling face can be precisely controlled, without the use of polishing. This disclosure also contemplates an optical fibre connector where the optical fibre mating endface 403 protrudes outwardly from the ferrule coupling face.

Utilising the concepts discussed above, a pre-fabricated connector can easily and cheaply be manufactured for supplying to a user such as a technician who is installing a fibre optic based network. The fibre optic connector may be integral to an existing fibre optic cable. Alternatively, the fibre optic connector may comprise a stub of optical fibre, which has a rear endface configured to be connected (e.g. via splicing) to a fibre optic cable. Therefore, a technician who wishes to connectorise an end of a fibre optic cable merely needs to splice an existing fibre optic cable with the rear endface of a fibre optic connector according to this disclosure. A complementary fibre optic cable can also be spliced with another fibre optic connector according to this disclosure, thus enabling the fibre optic cable and the complementary fibre optic cable to be reversibly attached via the fibre optic connectors. The technician is not required to undertake any polishing step, thus, the fibre optic connectors according to this disclosure may be referred to as “no-polish connectors”.

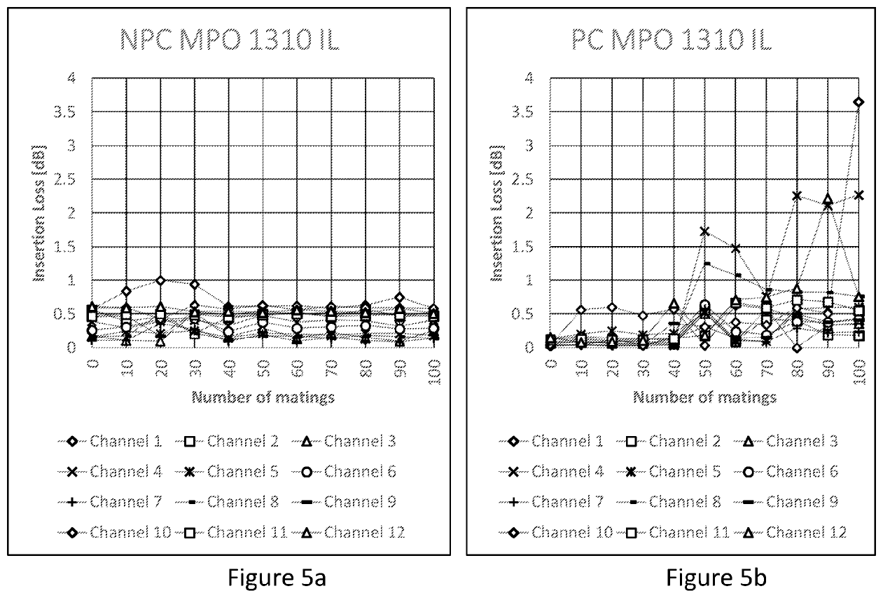

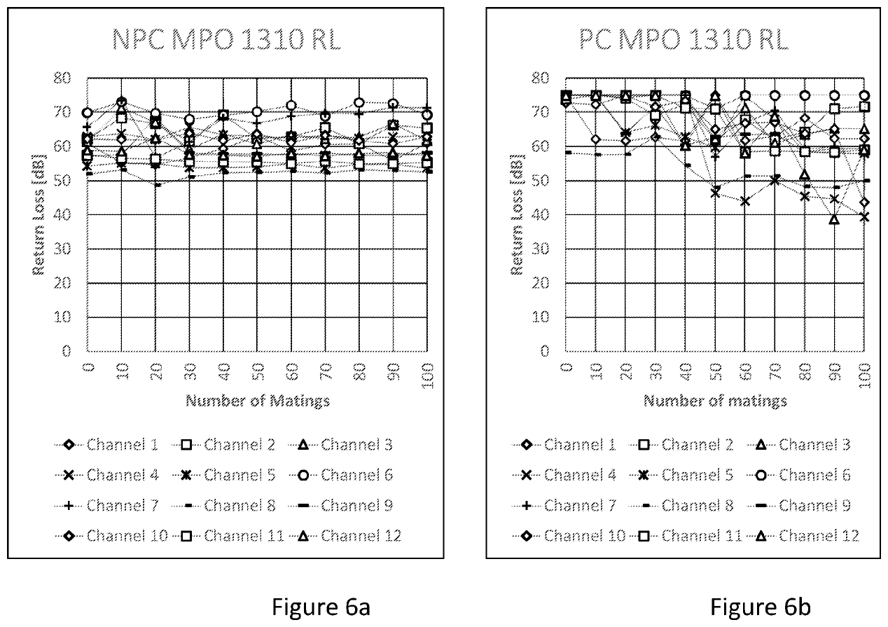

FIGS. 5a and 6a are plots showing the insertion and back-reflection performance of “no-polish connectors” (NPC) according to this disclosure. FIGS. 5b and 6b are plots showing comparative results with a conventional “polished” physical contact (PC) connectors wherein the mating endfaces of the PC are formed via a polishing process. The tested connectors are connecting a 12 fibre multi-fibre single mode ribbon transmitting light at 1310 nm wavelength. The conventional polished connectors are configured to provide a physical connection between mating endfaces of the optical fibres (i.e. there is no air gap). The Y axis of the plots of FIGS. 5a, 5b show the insertion loss in dB across the connector (wherein lower is better). The Y axis of the plots of FIGS. 6a, 6b show the return loss in dB across the connector (wherein higher is better). The X axis of each plot shows the number of connections and disconnections (matings) of the connector before the test has been undertaken. Each line on the plot indicates 12 individual fibres within a single connector being tested. The connectors have been cleaned with Cleatop™ tape before the first measurement. The connectors are cleaned with an air-gun after every 10 matings. It can be observed that for both insertion loss (FIGS. 5a, 5b) and return loss (FIGS. 6a, 6b), the performance of the NPC connectors according to this disclosure are generally more durable and reliable, and do not show the deterioration in performance with increased matings shown by a conventional physical contact connector. In particular, it is expected that all connectors will succumb to some contamination during each mating procedure, and therefore the plots show that the NPC connectors have improved resistance to contamination since the results of insertion loss and return loss remain particularly favourable after a high (>40) number of connections and disconnections. From these plots, it can be observed that the use of connectors with an air gap which include an optical fibre endface that has been formed and finished by cleaving, provides acceptable performance in comparison to polished connectors, and further, the provision of an air gap provides improved reliability of performance across a number of matings.

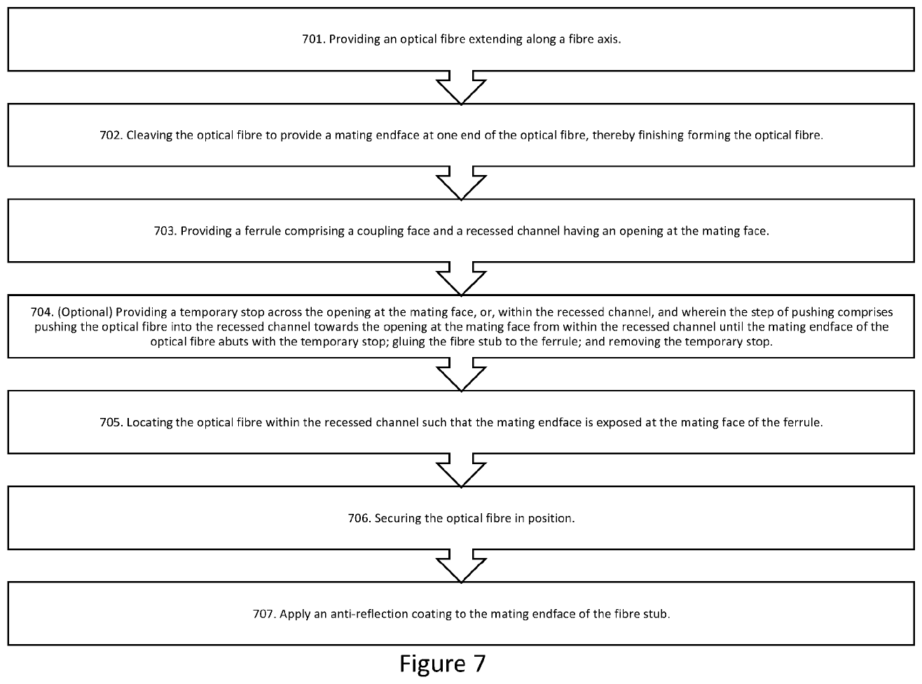

With reference to FIG. 7, a method of this disclosure comprises the steps of: providing an optical fibre extending along a fibre axis (701), cleaving the optical fibre to provide a mating endface at one end of the optical fibre, thereby finishing forming the optical fibre (702), providing a ferrule comprising a coupling face and a recessed channel having an opening at the mating face (703), optionally providing a temporary stop across the opening at the mating face, or, within the recessed channel, and wherein the step of pushing comprises pushing the optical fibre into the recessed channel towards the opening at the mating face from within the recessed channel until the mating endface of the optical fibre abuts with the temporary stop; gluing the fibre stub to the ferrule; and removing the temporary stop (704), locating the optical fibre within the recessed channel such that the mating endface is exposed at the mating face of the ferrule (705), securing the optical fibre in position (706), and, optionally applying an anti-reflection coating to the mating endface of the fibre stub (707). Application of the anti-reflection coating may alternatively occur before at any time before the step of securing the optical fibre in position (706).

1. An optical fibre connector for connecting to a complementary optical fibre connector, the optical fibre connector comprising:
a ferrule comprising a coupling face for coupling with a complementary coupling face of said complementary optical fibre connector; and
an optical fibre for optically mating with a complementary optical fibre of the complementary optical fibre connector, the optical fibre extending through the ferrule along a fibre axis and having a mating endface being exposed at the coupling face of the ferrule;
wherein a profile of the mating endface is formed and finished by cleaving.

2. The optical fibre connector according to claim 1, wherein the mating endface is at an acute angle with respect to the fibre axis, and optionally, wherein the acute angle is from 70 to 85 degrees and optionally from 81 to 84 degrees.

3. The optical fibre connector according to claim 1, wherein the mating endface is perpendicular to the fibre axis.

4. The optical fibre connector according to claim 1, wherein the mating endface is coated in an anti-reflection coating.

5. The optical fibre connector according to claim 1, wherein the ferrule coupling face is parallel to the mating endface of the optical fibre and/or wherein the ferrule coupling face is perpendicular to the fibre axis.

6. The optical fibre connector according to claim 1, wherein the mating endface has been tension cleaved.

7. The optical fibre connector according to claim 1, wherein the optical fibre is glued into the ferrule.

8. The optical fibre connector according to claim 1, wherein the fibre endface is recessed from the ferrule coupling face by a recess distance, the recess distance being from 0 micrometres to 25 micrometres, from 1 to 25 micrometres, from 3 micrometres to 15 micrometres, or approximately 6 micrometres.

9. The optical fibre connector according to claim 1, wherein a tip of the fibre mating endface is coincident with the ferrule coupling face.

10. The optical fibre connector according to claim 1, wherein the fibre endface protrudes from the ferrule coupling face by a protruding distance being from 0.01 micrometre to 9 micrometres, or, 1 micrometre to 6 micrometres, or, 1 micrometre to 3.5 micrometres.

11. The optical fibre connector according to claim 1, wherein the optical fibre is an optical fibre stub, wherein one end of the optical fibre stub comprises the mating endface, and the other end of the optical fibre stub is connectable to an optical fibre cable.

12. The optical fibre connector according to claim 11, wherein the optical fibre stub comprises a tail endface at an end which is opposite to the mating endface, the tail endface having been cleaved and comprising a surface that is perpendicular to the fibre axis.

13. The optical fibre connector according to claim 1 further comprising a plurality of optical fibres, wherein each of the plurality of optical fibres comprises a mating endface formed and finished by cleaving and exposed at the coupling face of the ferrule, and wherein each of the mating endfaces are parallel to one another.

14. An optical fibre cable comprising: at least one optical fibre and at least one optical fibre connector according to claim 1 at an end thereof.

15. A connector system comprising a pair of optical fibre connectors according claim 1, wherein the coupling face of the ferrule of one of the pair of optical fibre connectors is contactable with the coupling face of the ferrule of the other of the pair of optical fibre connectors.

16. The connector system according to claim 15, wherein at least one of the optical fibre connectors comprises a fibre mating endface being recessed from the ferrule coupling face such that an air gap is provided between the fibre mating endfaces of each of the pair of optical fibre connectors when the coupling faces of the ferrules of the pair of optical fibre connectors are in contact with one another.

17. The connector system according to claim 16, wherein the air gap is from 0 to 25 micrometres.

18. The connector system according to claim 16 further comprising index matching gel adjacent one or both of the fibre mating endaces of each of the pair of optical fibre connectors, thereby filling the air gap when the coupling faces of the ferrules of the pair of optical fibre connectors are in contact with one another.

19. A method of manufacturing an optical fibre connector, the method comprising:
providing an optical fibre extending along a fibre axis;
cleaving the optical fibre to provide a mating endface at one end of the optical fibre, thereby finishing forming the optical fibre;
providing a ferrule comprising a coupling face and a recessed channel having an opening at the mating face;
locating the optical fibre within the recessed channel such that the mating endface is exposed at the mating face of the ferrule; and
securing the optical fibre in position.

20. The method according to claim 19 further comprising, before the step of locating the optical fibre:
providing a temporary stop across the opening at the mating face, or, within the recessed channel, and wherein the step of locating the optical fibre within the recessed channel comprises pushing the optical fibre into the recessed channel towards the opening at the mating face from within the recessed channel until the mating endface of the optical fibre abuts with the temporary stop;
gluing the fibre stub to the ferrule; and
removing the temporary stop.
